(19) United States
(12) Patent Application Publication
(10) Pub. No.: US 2026/0187828 A1
(43) Pub. Date: Jul. 2, 2026

(54) MAP ALIGNMENT METHOD, MULTI-DEVICE SYSTEM AND NON-TRANSITORY COMPUTER READABLE STORAGE MEDIUM

(71) Applicant: HTC Corporation, Taoyuan City (TW)

(72) Inventor: Chun-Kai HUANG, Taoyuan City (TW)

(21) Appl. No.: 19/004,423

(22) Filed: Dec. 29, 2024

(51) Int. Cl. G06T 7/70; G02B 27/01

(52) U.S. Cl. CPC G06T 7/70; G02B 27/017

(57) ABSTRACT

The present disclosure provides a map alignment method and a multi-device system. The multi-device system is operable in a physical environment and includes a host device and a client device. The map alignment method includes: obtaining, by the host device and the client device, a host key frame and a client key frame at a preset time point, respectively; generating, by the host device, a first client pose according to the host key frame; and aligning, by the client device, a client map established by the client device detecting the physical environment with a host map established by the host device detecting the physical environment according to the first client pose.

### BACKGROUND

### Field of Invention

This disclosure relates to a method and a system, in particular to a map alignment method and a multi-device system.

### Description of Related Art

In the field of immersive experience system (e.g., a virtual reality (VR) system, an augmented reality (AR) system, a mixed reality (MR) system, etc.), some related arts make a head-mounted device (HMD) and at least one peripheral device (e.g., a controller, a tracker, etc.) exchange map data with each other to align the map of the at least one peripheral device with the map of the HMD. However, such approaches are inefficient and cause a huge burden to the processing resource.

### SUMMARY

An aspect of present disclosure relates to a map alignment method applicable to a multi-device system. The multi-device system is operable in a physical environment and includes a host device and a client device. The map alignment method includes: obtaining, by the host device and the client device, a host key frame and a client key frame at a preset time point, respectively; generating, by the host device, a first client pose according to the host key frame; and aligning, by the client device, a client map established by the client device detecting the physical environment with a host map established by the host device detecting the physical environment according to the first client pose.

Another aspect of present disclosure relates to a multi-device system operable in a physical environment. The multi-device system includes a host device and a client device. The host device is configured to establish a host map by detecting the physical environment. The client device is configured to establish a client map by detecting the physical environment. The host device and the client device are configured to obtain a host key frame and a client key frame at a preset time point, respectively. The host device is configured to generate a first client pose according to the host key frame, and the client device is configured to align the client map with the host map according to the first client pose.

Another aspect of present disclosure relates to a non-transitory computer readable storage medium with a computer program to execute a map alignment method applicable to a multi-device system. The multi-device system is operable in a physical environment and includes a host device and a client device. The map alignment method includes: obtaining, by the host device and the client device, a host key frame and a client key frame at a preset time point, respectively; generating, by the host device, a first client pose according to the host key frame; and aligning, by the client device, a client map established by the client device detecting the physical environment with a host map established by the host device detecting the physical environment according to the first client pose.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a block diagram of a multi-device system in accordance with some embodiments of the present disclosure;

FIG. 2 is a flow diagram of a map alignment method in accordance with some embodiments of the present disclosure;

FIG. 3 is a flow diagram of one operation of the map alignment method in accordance with some embodiments of the present disclosure;

FIG. 4 is a schematic diagram of a scenario of the multi-device system in accordance with some embodiments of the present disclosure;

FIG. 5 is a flow diagram of a map alignment method in accordance with some embodiments of the present disclosure; and

FIG. 6 is a schematic diagram of a multi-device system in accordance with some embodiments of the present disclosure.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

As used herein, “coupled” and “connected” may be used to indicate that two or more elements physical or electrical contact with each other directly or indirectly, and may also be used to indicate that two or more elements cooperate or interact with each other.

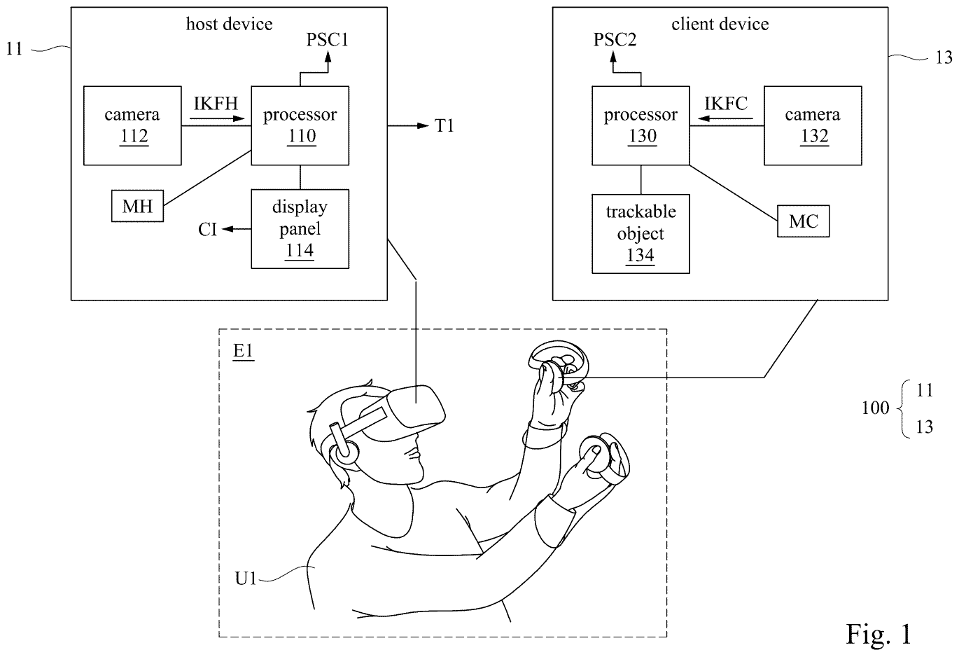

Referring to FIG. 1, FIG. 1 is a block diagram of a multi-device system 100 in accordance with some embodiments of the present disclosure. In some embodiments, the multi-device system 100 can be operated by a user U1 in a physical environment E1 (e.g., a gaming place, a workplace, a house, etc.), and can provides an immersive experience for the user U1.

In some embodiments, as shown in FIG. 1, the multi-device system 100 includes a host device 11 and at least one client device 13. In some practical applications, the host device 11 can be implemented with a wearable display device (e.g., a head-mounted device (HMD)) of an immersive system, and the client device 13 can be implemented with a controller device (e.g., a handheld controller, a wearable controller, etc.) of the immersive system.

In some embodiments, the host device 11 is configured to localize both itself and the client device 13 in the physical environment E1, and is configured to provide a visual feedback for the user U1 based on the localizations of the host device 11 and the client device 13. Accordingly, as shown in FIG. 1, the host device 11 includes a processor 110, a camera 112 and a display panel 114. The processor 110 is electrically and/or communicatively coupled to the camera 112 and the display panel 114.

In the above embodiments of the host device 11, the camera 112 is configured to capture multiple host-based images in the physical environment E1. It should be understood that these host-based images may include at least one of images of the whole or partial physical environment E1, images of the client device 13 and images of the user U1. By applying some feature extraction based localization technologies (e.g., Simultaneous Localization and Mapping (SLAM)) to the host-based images captured by the camera 112, the processor 110 can be configured to establish a host map MH of the physical environment E1, and further configured to calculate the position and/or orientation of the host device 11 in the host map MH. The processor 110 is configured to use some interaction-based tracking technologies (e.g., optical tracking) to calculate the position and/or orientation of the client device 13 relative to the host device 11. Also, the processor 110 is configured to generate at least one visual content according to the positions and/or orientations of the host device 11 and the client device 13. The display panel 114 is configured to display the at least one visual content generated by the processor 110, so as to provide an immersive content CI (i.e., the visual feedback) for the user U1.

In some embodiments, the host device 11 may occlude the direct visibility of the user U1 to the physical environment E1. In this case, the immersive content CI can be a virtual reality (VR) environment, or a mixed reality (MR) environment. In particular, the virtual reality environment may include at least one virtual reality object, which cannot be directly seen in the physical environment E1 by the user U1. The mixed reality environment simulates the physical environment E1 and enables an interaction of the at least one virtual reality object with a simulated physical environment. However, the present disclosure is not limited herein. For example, the immersive content CI can be the simulated physical environment without the virtual reality objects, which is known as a pass-through view.

In some embodiments, the host device 11 does not occlude the direct visibility of the user U1 to the physical environment E1. In this case, the immersive content CI can be an augmented reality (AR) environment. In particular, the augmented reality environment augments the physical environment E1 directly seen by the user U1 with the at least one virtual reality object.

In some embodiments, the client device 13 is configured to localize itself in the physical environment E1, and is configured to interact with the host device 11 to facilitate the localization of the client device 13 performed by the host device 11. Accordingly, as shown in FIG. 1, the client device 13 includes a processor 130, a camera 132 and at least one trackable object 134. The processor 130 is electrically and/or communicatively coupled to the camera 132 and the trackable object 134. In particular, the trackable object 134 is arranged on the exterior surfaces of the client device 13 to be directly seen by the user U1 or be directly captured by the camera 112 of the host device 11. Moreover, in accordance with the above embodiments that the immersive content CI is the virtual reality environment, the mixed reality environment or the augmented reality environment, the user U1 can control the at least one virtual reality object in the immersive content CI with the client device 13.

In the above embodiments of the client device 13, the camera 132 is configured to capture multiple client-based images in the physical environment E1. It should be understood that these client-based images may include at least one of images of the whole or partial physical environment E1, images of the host device 11 and images of the user U1. By applying some feature extraction based localization technologies (e.g., SLAM) to the client-based images captured by the camera 132, the processor 130 can be configured to establish a client map MC of the physical environment E1, and further configured to calculate the position and/or orientation of the client device 13 in the client map MC. Also, the processor 130 is configured to actuate the trackable object 134 to allow the client device 13 to interact with the host device 11. For example, when the trackable object 134 is actuated, the processor 110 of the host device 11 can recognize images of the trackable object 134 arranged on the client device 13 from the host-based images captured by the camera 112 of the host device 11.

In the above embodiments, the processor 110 and the processor 130 each can be implemented with a central processing unit (CPU), a graphic processing unit (GPU), an application-specific integrated circuit (ASIC), a microprocessor, a system on a Chip (SoC) or other suitable processing circuits. The display panel 114 can be implemented with an active matrix organic light emitting diode (AMOLED) display, organic light emitting diode (OLED) display, or other suitable displays. The trackable object 134 can be implemented with an infrared light emitting diode (LED), but is not limited thereto. For example, in some embodiment, the trackable object 134 may be the whole or partial physical shape of the client device 13, which can be pre-stored in the host device 11 and be recognized by the host device 11.

In addition, the host device 11 and the client device 13 each can further include a motion sensor (e.g., an inertial measurement unit (IMU) including an accelerometer, a gyroscope and a magnetometer), a storage (e.g., a volatile memory, a non-volatile memory, etc.) and/or a communicator (e.g., a Wi-Fi module, a Bluetooth Low Energy (BLE) module, a Bluetooth module, etc.). The motion sensor can be used to sense the movement of the host device 11 or the client device 13 to generate motion data correspondingly, in which the motion data can be used to calculate the position and/or orientation of the host device 11 or the client device 13 by some mathematical calculations. The storage can be used to store signals, data and/or information, such as the motion data, the above-described images, the host map MH, the client map MC, the physical shape of the client device 13 (which is used as the trackable object 134), the position and/or orientation of the host device 11 or the client device 13, etc. The host device 11 and the client device 13 can use the communicator to communicate with each other or other devices (e.g., transferring signals, data and/or information).

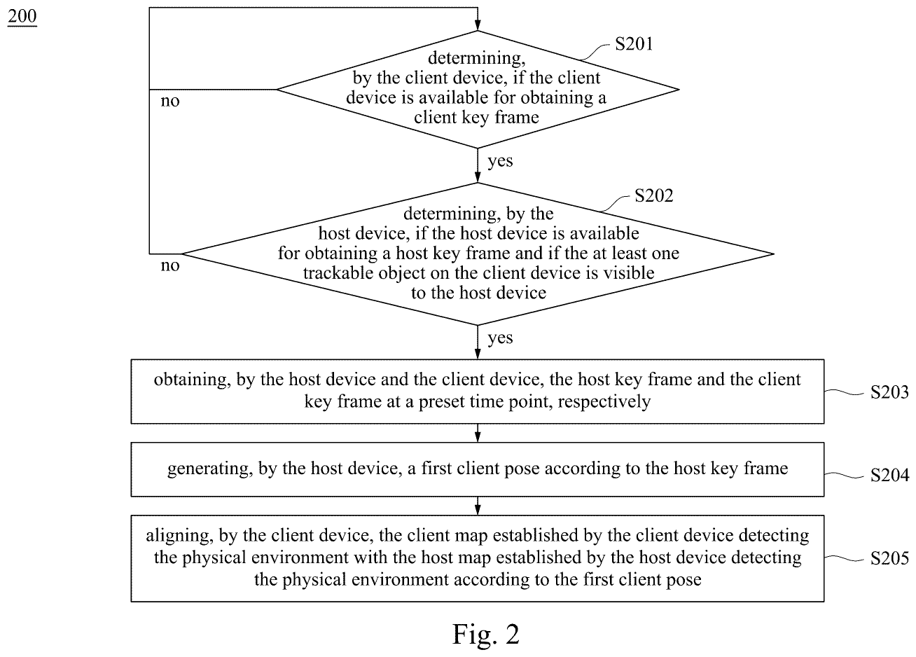

In some embodiments, the host device 11 and the at least one client device 13 in the multi-device system 100 must achieve map consistency in order to improve the user experience of the user U1 and the immersion of the user U1 in the immersive content CI. Notably, the multi-device system 100 can perform a map alignment method 200 to achieve the map consistency between the host device 11 and the at least one client device 13, which would be described in detail below with reference to FIG. 2.

Referring to FIG. 2, FIG. 2 is a flow diagram of the map alignment method 200 in accordance with some embodiments of the present disclosure. In some embodiments, as shown in FIG. 2, the map alignment method 200 includes operations S201-S205. However, the present disclosure should not be limited thereto.

In operation S201, the client device 13 determines if the client device 13 is available for obtaining a client key frame IKFC. In some embodiments, the processor 130 of the client device 13 calculates a processor utilization of the processor 130 to determine if the client device 13 is available for obtaining the client key frame IKFC. For example, when the processor utilization is lower than an execution threshold (e.g., 90%), the processor 130 determines that the client device 13 is available for obtaining the client key frame IKFC, so that operation S202 would be performed. When the processor utilization exceeds the execution threshold, the processor 130 determines that the client device 13 is not available for obtaining the client key frame IKFC, so that operation S201 would be performed again.

In operation S202, the host device 11 determines if the host device 11 is available for obtaining a host key frame IKFH and if the at least one trackable object 134 on the client device 13 is visible to the host device 11. In some embodiments, the processor 110 of the host device 11 calculates a processor utilization of the processor 110 to determine if the host device 11 is available for obtaining the host key frame IKFH, which is similar to those of the processor 130 of the client device 13. Meanwhile, the processor 110 searches or recognizes the images of the trackable object 134 from the host-based images captured by the camera 112 to determine if the trackable object 134 is visible to the host device 11. When the images of the trackable object 134 can be found or recognized, the processor 110 determines that the trackable object 134 is visible to the host device 11. When the images of the trackable object 134 cannot be found or recognized, the processor 110 determines that the trackable object 134 is not visible to the host device 11.

In some embodiments of operation S202, the processor 110 determines that the host device 11 is available for obtaining the host key frame IKFH and that the trackable object 134 is visible to the host device 11, so that operation S203 would be performed. Also, in some embodiments of operation S202, the processor 110 determines that the host device 11 is not available for obtaining the host key frame IKFH or that the trackable object 134 is not visible to the host device 11, so that operation S201 would be performed again.

In operation S203, the host device 11 and the client device 13 obtain the host key frame IKFH and the client key frame IKFC at a preset time point, respectively. In some embodiments of operation S203, at the preset time point, the processor 110 selects at least one image from the host-based images as the host key frame IKFH by the feature extraction based localization technologies, and the processor 130 selects at least one image from the client-based images as the client key frame IKFC by the feature extraction based localization technologies. From the descriptions of operations S201-S203, it can be seen that when the trackable object 134 on the client device 13 is visible to the host device 11, the host device 11 and the client device 13 would obtain their own key frames (i.e., the host key frame IKFH and the client key frame IKFC) at the preset time point on which they agree.

In some embodiments, before operation S203 is performed, the host device 11 and the client device 13 synchronize time between the host device 11 and the client device 13. For example, the host device 11 can exchange timestamps with the client device 13, so that a time difference between two clock signals, respectively, followed by the processor 110 and the processor 130 and/or a data transmission delay time between the host device 11 and the client device 13 can be calculated. One of the host device 11 and the client device 13 can adjust its clock signal according to the time difference and/or the data transmission delay time, so that the two clock signals can have the same phase and frequency.

In accordance with the above descriptions, the processor 110 determines to obtain the host key frame IKFH at the preset time point. As shown in FIG. 1, the host device 11 can utilize the processor 110 to transmit a timestamp T1, which indicates the preset time point, to the client device 13. By receiving the timestamp T1, the processor 130 is aware that it should obtain the client key frame IKFC at the preset time point. In brief, after the time synchronization, the host device 11 notifies the client device 13 of the preset time point when the host key frame IKFH and the client key frame IKFC are obtained.

In operation S204, the host device 11 generates a first client pose PSC1 according to the host key frame IKFH. In some embodiments, the host key frame IKFH includes the images of the trackable object 134. Accordingly, the processor 110 may perform, for example triangulation, on the host key frame IKFH to calculate the position and/or orientation of the trackable object 134 relative to the camera 112. As should be understood, because the origin of the host map MH may be the position and/or orientation of the camera 112, the position and/or orientation of the trackable object 134 relative to the camera 112 can be used to represent the position and/or orientation of the client device 13 in host map MH of the physical environment E1. In the embodiments of FIG. 1, pose data of the trackable object 134 (i.e., the position and/or orientation of the trackable object 134 relative to the camera 112) is directly used by the processor 110 as the first client pose PSC1, which can indicate the position and/or orientation of the client device 13 in host map MH.

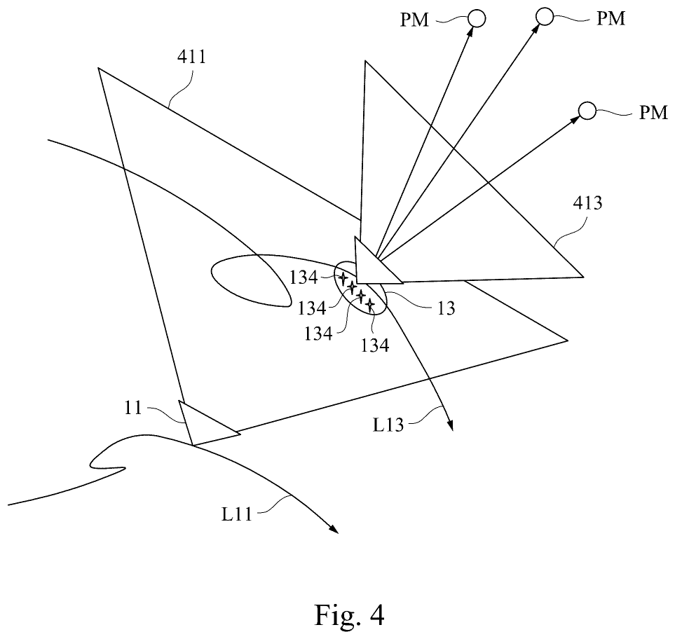

In some embodiments, as shown in FIG. 1, while the host device 11 generates the first client pose PSC1, the client device 13 generate a second client pose PSC2 corresponding to the client key frame IKFC through the feature extraction based localization technologies. In particular, by the feature extraction based localization technologies, the processor 130 extracts multiple feature points from the client key frame IKFC, and matches these feature points to multiple map points PM (which are shown in FIG. 4) in the client map MC to determine the position and/or orientation of the client device 13 in the client map MC of the physical environment E1. In some embodiments, pose data of the client device 13 (i.e., the position and/or orientation of the client device 13 in the client map MC) is directly used by the processor 130 as the second client pose PSC2.

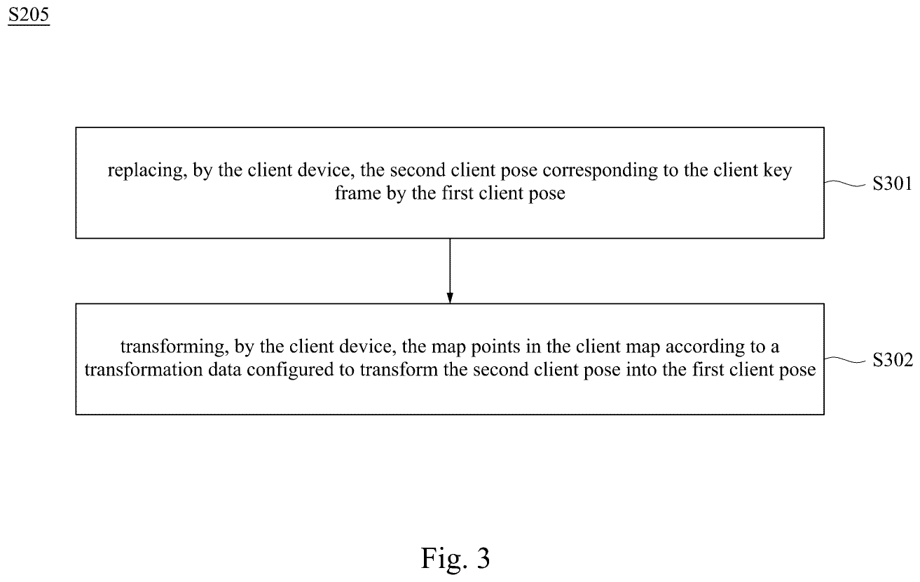

In some embodiments, the host device 11 transmits the first client pose PSC1 and the host key frame IKFH to the client device 13 after operation S204, so that operation S205 is performed. In operation S205, the client device 13 aligns the client map MC established by the client device 13 detecting the physical environment E1 with the host map MH established by the host device 11 detecting the physical environment E1 according to the first client pose PSC1, which would be described in detail below with reference to FIG. 3. FIG. 3 is a flow diagram of operation S205 in accordance with some embodiments of the present disclosure. In some embodiments, as shown in FIG. 3, operation S205 includes sub-operations S301-S302.

In sub-operation S301, the client device 13 replaces the second client pose PSC2 corresponding to the client key frame IKFC by the first client pose PSC1. In other words, the client key frame IKFC is corresponding to the first client pose PSC1 after sub-operation S301.

In sub-operation S302, the client device 13 transforms the map points PM in the client map MC according to a transformation data (not shown in drawings) configured to transform the second client pose PSC2 into the first client pose PSC1. In some embodiments, the processor 130 calculates the transformation data by performing a matrix calculation between the first client pose PSC1 and the second client pose PSC2. For example, the processor 130 multiplies the first client pose PSC1 and an inverse of the second client pose PSC2, so as to obtain data capable of making the second client pose PSC2 into the first client pose PSC1 as the transformation data. In some embodiments of sub-operation S302, the processor 130 multiplies each map point in the client map MC by the transformation data. After sub-operation S302, the coordinate of each map point in the client map MC becomes relative to the origin of the host map MH instead of the origin of the client map MC.

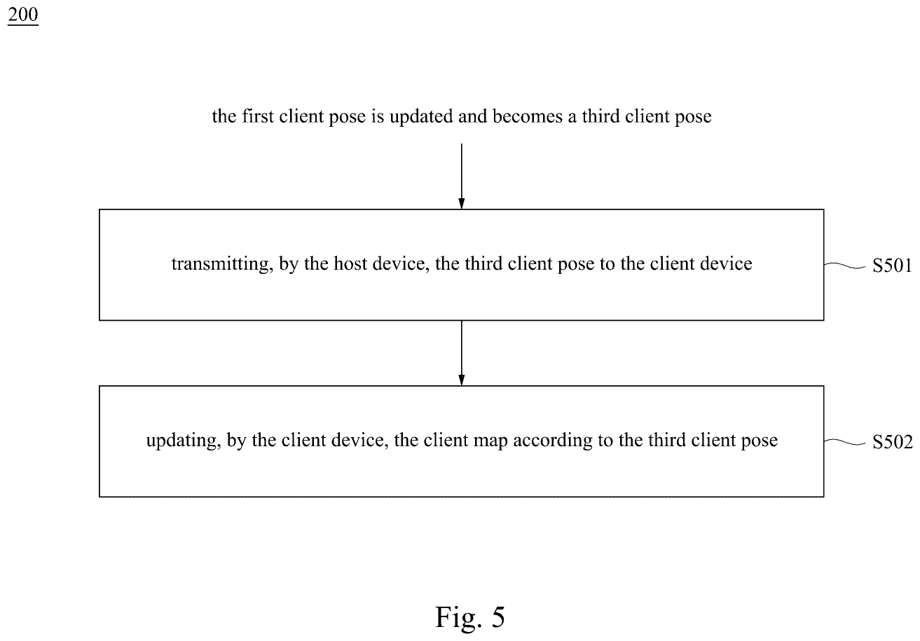

The map alignment method 200 of the present disclosure is not limited to the embodiments of FIG. 2, which would be described in detail with reference to FIGS. 4 and 5. FIG. 4 is a schematic diagram of a scenario of the multi-device system 100 in accordance with some embodiments of the present disclosure. FIG. 5 is another flow diagram of the map alignment method 200 in accordance with some embodiments of the present disclosure.

In some embodiments, after the host key frame IKFH and the client key frame IKFC are obtained and the first client pose PSC1 and the second client pose PSC2 are calculated, the user U1 operating the multi-device system 100 may move in the physical environment E1. When the user U1 is moving in the physical environment E1, as shown in FIG. 4, the pose of the host device 11 and a field of view 411 of the camera 112 may be changed as the host device 11 is moved along an arrow L11, and the pose of the client device 13 and a field of view 413 of the camera 132 may be changed as the client device 13 is moved along an arrow L13. During the pose change of the host device 11, the processor 110 of the host device 11 may obtain a new key frame (not shown in drawings) through the feature extraction based localization technologies. In the embodiments of FIG. 4, this new key frame can include the images of the trackable object 134 because the trackable objects 134 on the client device 13 are in the field of view 411 of the camera 112 of the host device 11.

In accordance with the above embodiments, the processor 110 may use the new key frame to update the host map MH of the physical environment E1. For example, because a new pose of the host device 11 corresponding to the new key frame is used as a new origin of the host map MH, as shown in FIG. 5, the first client pose PSC1 corresponding to the host key frame IKFH of the host map MH is updated and becomes a third client pose. In the embodiments of FIG. 5, after the first client pose PSC1 becomes the third client pose, operation S501 is performed.

In operation S501, the host device 11 transmits the third client pose to the client device 13. In some embodiments, when the client device 13 receives the third client pose, operation S502 is performed. In operation S502, the client device 13 updates the client map MC according to the third client pose.

In some embodiments of operation S502, the processor 130 of the client device 13 replaces the first client pose PSC1 corresponding to the client key frame IKFC by the third client pose. Furthermore, the processor 130 can update the transformation data or re-generate the transformation data according to the second client pose PSC2 and the third client pose, which can refer to the descriptions of sub-operation S302. For example, the processor 130 can obtain data capable of making the second client pose PSC2 into the third client pose as the transformation data by multiplying the third client pose and the inverse of the second client pose PSC2. Accordingly, the processor 130 can perform the transformation on the map points PM in the client map MC by the transformation data configured to transform the second client pose PSC2 into the third client pose. In such arrangements, the client map MC established by the client device 13 is updated and is aligned with the host map MH updated by the host device 11.

As can be seen from the above embodiments of the present disclosure, by the host device 11 and the client device 13 generating the key frame pair (i.e., the host key frame IKFH and the client key frame IKFC), the client device 13 can use the pose (e.g., the first client pose PSC1, the third client pose, etc.) corresponding to the host key frame IKFH to constantly align the client map MC with the host map MH. In such way, the multi-device system 100 can achieve the map consistency between the devices therein in a highly efficient way, and has advantages of low processing resource, etc.

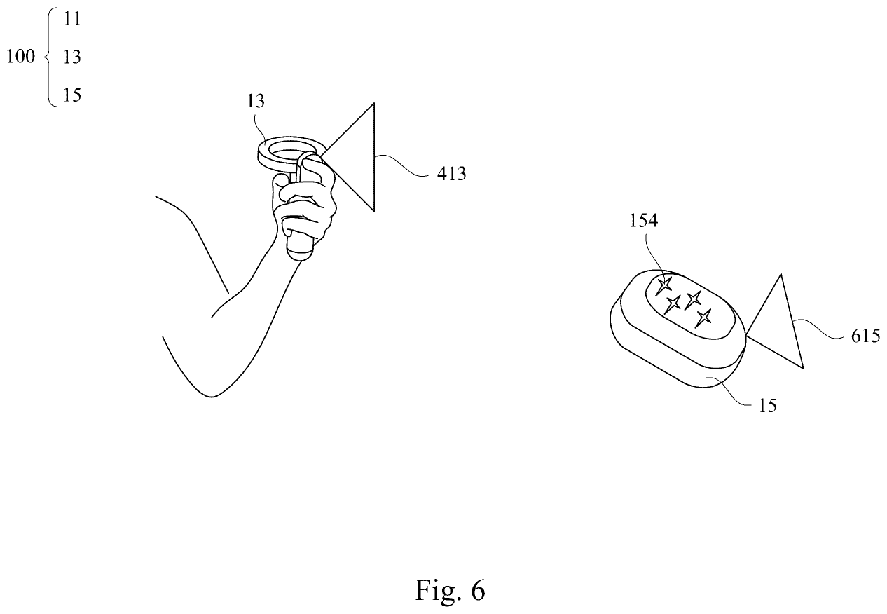

It should be understood that the map alignment method 200 is not limited to be applied to the multi-device system 100 as shown in FIG. 1, which would be described in detail below with reference to FIG. 6. FIG. 6 is a schematic diagram of the multi-device system 100 in accordance with some embodiments of the present disclosure. In some embodiments, as shown in FIG. 6, the multi-device system 100 further includes another client device 15, that is, the multi-device system 100 includes the host device 11, the client device 13 and the client device 15. The client device 15 can be a tracker of the immersive system configured to track the movement of the user U1 in the environment E1 and has configurations similar to the client device 13. For example, in FIG. 6, there are four trackable objects 154 on the client device 15, and a camera of the client device 15 has a field of view 615.

In the embodiments of FIG. 6, the client device 13 and the client device 15 can execute the map alignment method 200. For example, the client device 13 determines if the trackable object 154 on the client device 15 is visible to the client device 13 in the field of view 413. When the trackable object 154 on the client device 15 is visible to the client device 13, the client device 13 and the client device 15 can obtain their own key frames (hereafter regarded as a first key frame and a second key frame) at a time point on which they agree. The client device 13 then calculates a first pose of the client device 15 corresponding to the first key frame, which can refer to the descriptions of operation S204. The client device 15 can align its map with the client map MC of the client device 13 by replacing a second pose of the client device 15 corresponding to the second key frame by the first pose, which can refer to the descriptions of operation S205.

The disclosed methods, may take the form of a program code (i.e., executable instructions) embodied in tangible media, such as floppy diskettes, CD-ROMS, hard drives, or any other transitory or non-transitory machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A map alignment method, applicable to a multi-device system, wherein the multi-device system is operable in a physical environment and comprises a host device and a client device, and the map alignment method comprises:
obtaining, by the host device and the client device, a host key frame and a client key frame at a preset time point, respectively;
generating, by the host device, a first client pose according to the host key frame; and
aligning, by the client device, a client map established by the client device detecting the physical environment with a host map established by the host device detecting the physical environment according to the first client pose.

2. The map alignment method of claim 1, wherein before obtaining, by the host device and the client device, the host key frame and the client key frame at the preset time point, respectively, the map alignment method further comprises:
synchronizing, by the host device and the client device, time between the host device and the client device; and
notifying, by the host device, the client device of the preset time point when the host key frame and the client key frame are obtained.

3. The map alignment method of claim 1, wherein generating, by the host device, the first client pose according to the host key frame comprises:
calculating, by the host device, pose data of at least one trackable object134 on the client device from the host key frame, to generate the first client pose.

4. The map alignment method of claim 1, wherein aligning, by the client device, the client map with the host map according to the first client pose comprises:
replacing, by the client device, a second client pose corresponding to the client key frame by the first client pose; and
transforming, by the client device, a plurality of map points in the client map according to a transformation data configured to transform the second client pose into the first client pose.

5. The map alignment method of claim 1, further comprising:
generating, by the client device, a second client pose corresponding to the client key frame through a feature extraction based localization technology.

6. The map alignment method of claim 1, further comprising:
determining, by the client device, if the client device is available for obtaining the client key frame or not.

7. The map alignment method of claim 6, further comprising:
when the client device is available for obtaining the client key frame, determining, by the host device, if the host device is available for obtaining the host key frame or not and if at least one trackable object on the client device is visible to the host device or not,
wherein when the host device is available for obtaining the host key frame and the at least one trackable object on the client device is visible to the host device, the host device and the client device obtain the host key frame and the client key frame at the preset time point, respectively.

8. The map alignment method of claim 1, wherein after the first client pose is updated and becomes a third client pose, the map alignment method further comprises:
transmitting, by the host device, the third client pose to the client device.

9. The map alignment method of claim 8, further comprising:
updating, by the client device, the client map according to the third client pose.

10. The map alignment method of claim 9, wherein updating, by the client device, the client map according to the third client pose comprises:
replacing, by the client device, the first client pose corresponding to the client key frame by the third client pose.

11. A multi-device system, operable in a physical environment, and comprising:
a host device, configured to establish a host map by detecting the physical environment; and
a client device, configured to establish a client map by detecting the physical environment,
wherein the host device and the client device are configured to obtain a host key frame and a client key frame at a preset time point, respectively, and
wherein the host device is configured to generate a first client pose according to the host key frame, and the client device is configured to align the client map with the host map according to the first client pose.

12. The multi-device system of claim 11, wherein the host device and the client device are further configured to synchronize time between the host device and the client device, and the host device is further configured to notify the client device of the preset time point when the host key frame and the client key frame are obtained.

13. The multi-device system of claim 11, wherein the host device is configured to calculate pose data of at least one trackable object on the client device from the host key frame, to generate the first client pose.

14. The multi-device system of claim 11, wherein the client device is configured to replace a second client pose corresponding to the client key frame by the first client pose, and is configured to transform a plurality of map points in the client map according to a transformation data configured to transform the second client pose into the first client pose.

15. The multi-device system of claim 11, wherein the client device is further configured to determine if the client device is available for obtaining the client key frame or not.

16. The multi-device system of claim 15, wherein when the client device is available for obtaining the client key frame, the host device is further configured to determine if the host device is available for obtaining the host key frame or not and if at least one trackable object on the client device is visible to the host device or not, and
wherein when the host device is available for obtaining the host key frame and the at least one trackable object on the client device is visible to the host device, the host device and the client device obtain the host key frame and the client key frame at the preset time point, respectively.

17. The multi-device system of claim 11, wherein after the first client pose is updated and becomes a third client pose, the host device is further configured to transmit the third client pose to the client device.

18. The multi-device system of claim 17, wherein the client device is further configured to update the client map according to the third client pose.

19. The multi-device system of claim 18, wherein the client device is configured to replace the first client pose corresponding to the client key frame by the third client pose.

20. A non-transitory computer readable storage medium with a computer program to execute a map alignment method applicable to a multi-device system, wherein the multi-device system is operable in a physical environment and comprises a host device and a client device, and the map alignment method comprises:
obtaining, by the host device and the client device, a host key frame and a client key frame at a preset time point, respectively;
generating, by the host device, a first client pose according to the host key frame; and
aligning, by the client device, a client map established by the client device detecting the physical environment with a host map established by the host device detecting the physical environment according to the first client pose.
